(19) United States
(12) Patent Application Publication
(10) Pub. No.: US 2006/0149569 A1
(43) Pub. Date: Jul. 6, 2006

(54) Method for transitioning foreign employees

(76) Inventors: Neha Lal, Glen Allen, VA (US); Amitabh Hajela, Stamford, CT (US)

Correspondence Address: DRINKER BIDDLE & REATH;ATTN: INTELLECTUAL PROPERTY GROUP, ONE LOGAN SQUARE, 18TH AND CHERRY STREETS, PHILADELPHIA, PA, 19103-6996, US

(21) Appl. No.: 11/026,723

(22) Filed: Dec. 30, 2004

(51) Int. Cl. G06Q 99/00

(52) U.S. Cl. 705/1

(57) ABSTRACT

The present invention provides a method for transitioning a foreign national employee from a foreign location to a domestic business location using a web-based employee service center. The method comprises providing a web-based employee service center comprising an information center, a form download center, a frequently asked question center, an enrollment center, and a request for service center; assigning a unique user access identification to a foreign national employee, whereby said foreign national employee can access said employee service center; providing at least one checklist of required transition tasks to said foreign national employee; providing a list of available transition services to said foreign national employee via said employee service center; prompting said foreign national employee to complete at least one task via said web-based employee service center; processing at least one request for a transition service made by said foreign national employee via said web-based employee service center; and tracking completion of said at least one request for a transition service via said web-based employee service center.

### FIELD OF THE INVENTION

The present invention relates to a method for transitioning a foreign national employee from a foreign location to a domestic business location using a web-based employee service center.

### BACKGROUND OF THE INVENTION

In today's economy, one of the biggest problems facing companies is the ability to meet their staffing needs for skilled workers. Modem business practice demands that companies employ lean staffing policies so that all employees are being utilized efficiently. At the same time, however, modem business practice requires companies to be able to react in a timely fashion to a demand for their services, and hence an increased demand for employees, lest the company lose business to a better-staffed competitor.

Some companies deal with these staffing issues by hiring temporary workers. While the hiring of temporary workers is sufficient in some cases to meet a company's needs, there are inherent difficulties with hiring such workers. For example, the skill level of temporary workers is unknown and therefore companies take a risk in hiring such workers. Further, hiring such workers frequently involves transactional costs such as time lost searching for a qualified temporary worker, hiring fees to hire the worker, and time lost for initial training and orientation of the worker. One final drawback to hiring temporary workers is that it is not always possible to hire a worker with the required skill level at the time such a worker is needed.

Many international companies attempt to meet their need for skilled workers by transferring employees from their foreign locations to their domestic business locations. This practice overcomes many of the disadvantages inherent with hiring temporary workers, as transferred employees have a known skill level, their hiring does not involve hiring fees, and the availability of such employees can be more easily arranged if such employees already work for the company.

However, the transfer by international companies of employees from their foreign locations to their domestic business locations has its own difficulties. One of the biggest difficulties faced by companies that transfer employees is being able to easily transition such employees so that such employees can focus on their work rather than spending their time searching for information regarding the myriad issues associated with relocating to a foreign country. For example, foreign employees have to acquire and fill out the appropriate immigration forms to allow them to work domestically. In addition, foreign employees will have to find housing and transportation, and will have to arrange for the shipping and storage of their personal belongings. Further, foreign employees will have to fill out various tax and payroll forms.

The current methods for distributing information and making available services to foreign employees consists primarily of giving the foreign employee a packet of information containing information concerning immigration, housing, transportation, shipping and storage, taxes, and payroll. A major drawback to this type of method is that there is no safeguard that the employee will receive and retain the relevant information. Initially, there are questions as to where to send the packet. If the packet is sent to the foreign country in which the employee normally works, there is a risk that the packet will never get to the employee. In addition, if the packet is sent to the foreign country in which the employee normally works, there is the risk that the employee will forget to bring the packet to the domestic location. This risk is very real, in light of the fact that the employee will likely also be moving a large number of personal effects and work-related effects to the domestic location. If the packet is sent to the domestic office to which the foreign employee is moving, the employee will not receive necessary information, such as information concerning immigration, housing, and automobile rentals, that the employee will need before moving.

Another major drawback to providing a foreign employee with a packet of information is that this method does not insure that the employee is receiving the most up-to-date information and services. Frequently, companies will try to give an employee of a foreign location as much notice as possible before moving the employee to a domestic location, to allow the foreign employee to make any necessary arrangements. Thus, for example, an employee may be given 2 months notice that he or she will be transferred to a domestic location. If the employee is sent a packet with housing information 2-3 months before their move, the housing information can be stale be the time they are ready to obtain housing. Likewise, if an employee is given several months notice before a move, immigration information that was sent to the employee may have changed by the time the employee is ready to fill out the necessary forms.

Another drawback to providing a foreign employee with a packet of information is that this method greatly slows down the speed of the transition for the potential employee. Frequently, positions need to be filled quickly in order to efficiently meet work demand. Having to provide a potential foreign employee with transition information greatly slows this process, delaying the start date for the potential foreign employee. This delay is not only inefficient to the potential employer, it also creates inefficiency for the potential employee who cannot achieve maximum utilization because of the delays caused by the use of a packet.

A further drawback to providing a foreign employee with a packet of information is that this method does not provide an easy method to process requests for various types of services, such as car rentals and salary advances. Moreover, because the packet is not interactive, it does not provide the employee with an easy method to make requests or ask questions, nor does it provide the employer with an easy method to receive and respond to such requests or questions.

Another drawback to providing a foreign employee with a packet of information is that this method does not provide a company or the employee with the ability to track the employees progress in making the transition from the foreign to the domestic company.

One other drawback to providing a foreign employee with a packet of information is that this method does not safeguard the employee from accidentally filling our information in an incorrect manner. Typically, such errors can include wrong formats, incomplete information etc., which necessitate the review and rework on the forms. These issues end up creating significant delays and potential errors in matters of compliance with immigration, taxation and labor laws, each of which pose a significant risk to the employer.

### BRIEF SUMMARY OF THE INVENTION

Accordingly, the present invention provides a method for international companies to transition skilled foreign employees to domestic business locations as they are needed to fulfill their staffing needs, without the drawbacks of the currently used method of providing information and services. To achieve this, the present invention provides a web-based employee service center comprising an information center, a form download center, a frequently asked question center, an enrollment center, and a request for service center; assigns a unique user access identification to a foreign national employee, whereby said foreign national employee can access said employee service center; provides at least one checklist of required transition tasks to said foreign national employee; providing a list of available transition services to said foreign national employee via said employee service center; prompting said foreign national employee to complete at least one task via said web-based employee service center; processing at least one request for a transition service made by said foreign national employee via said web-based employee service center; and tracking completion of said at least one request for a transition service via said web-based employee service center.

### BRIEF DESCRIPTION OF THE DRAWINGS

FIG. 1 is an embodiment of the method of the invention;

FIG. 2 is an embodiment of the web-based employee service center;

FIG. 3 is an embodiment of a login page for the web-based employee service center;

FIG. 4 an embodiment of the information center of the web-based employee service center;

FIG. 5 is an embodiment of the downloadable form center of the web-based employee service center;

FIG. 6 is an embodiment of the frequently asked questions center of the web-based employee service center;

FIG. 7 is an embodiment of the enrollment center of the web-based employee service center;

FIG. 8 is an embodiment of a specific section of the enrollment center;

FIG. 9 is an embodiment of the message board (employee interaction center) of the web-based employee service center;

FIG. 10 is an embodiment of the request for service center of the web-based employee service center;

FIG. 11 is an embodiment of a section of the request for service center of the web-based employee service center;

FIG. 12 is an embodiment of the administrative portal of the web-based employee service center;

FIG. 13 is an embodiment of a checklist on the information center of the web-based employee service center;

FIG. 14 is another embodiment of a checklist on the information center of the web-based employee service center;

FIG. 15 is an embodiment of an electronic form on the web-based employee service center;

FIG. 16 is an embodiment of the error checking of the electronic form on the web-based employee service center;

FIG. 17 is a business process map for the fax confirmation of documents for requests;

FIG. 18 is a business process map for administration by process owners and process viewers;

FIG. 19 is an embodiment of assigning third-party processors through the administrative portal of the web-based employee service center;

FIG. 20 is a business process map for the third-party processing of requests;

FIG. 21 is an embodiment of the customized report generator of the web-based service center;

FIG. 22 is an embodiment of the electronic tracking of the completion of requests on the web-based service center; and

FIG. 23 is an embodiment of the electronic tracking of requests on the web-based service center.

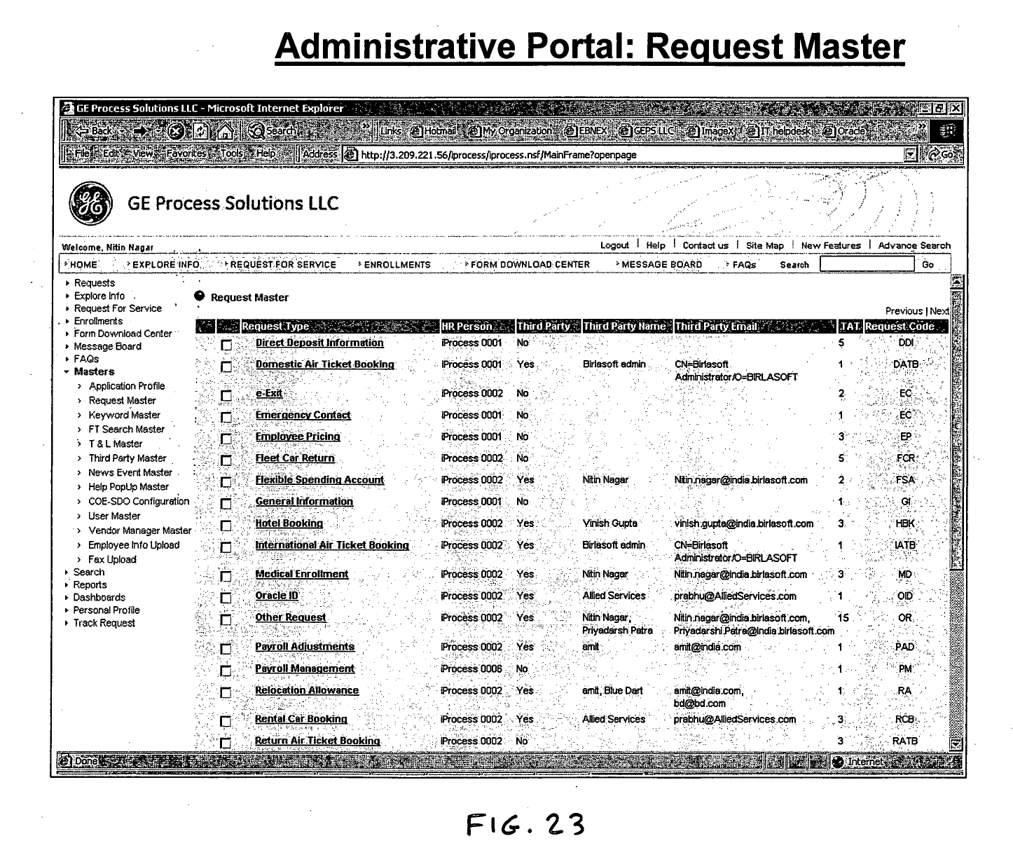

### DETAILED DESCRIPTION OF THE INVENTION

The present invention provides a method for international companies to transition skilled foreign employees to domestic business locations through the use of a web-based employee service center.

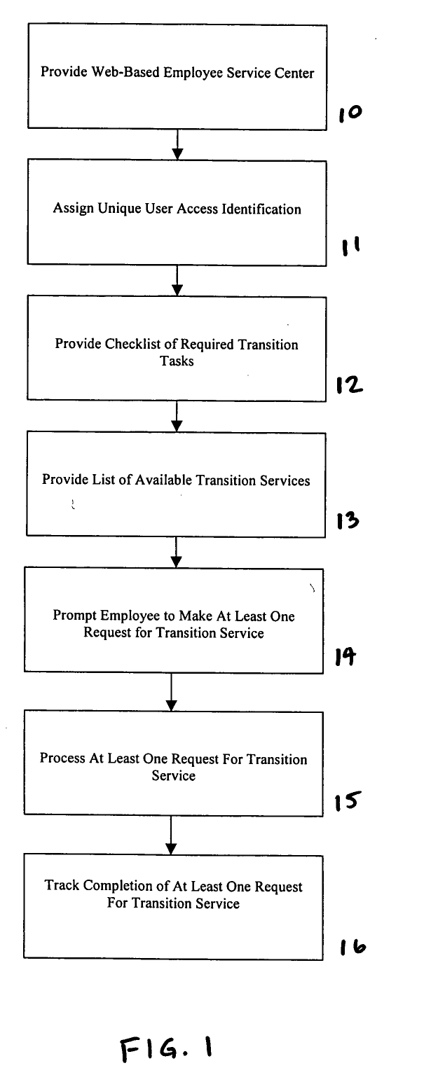

As shown in FIG. 1, the preferred embodiment of this invention involves the following steps: providing a web-based employee service center 10 comprising an information center, a form download center, a frequently asked question center, an enrollment center, a request for service center, and an administrative portal; assigning a unique user access identification 11 to a foreign national employee to be transitioned to a domestic business location from a foreign location, to allow said foreign national employee to access said employee service center; providing at least one checklist of required transition tasks 12 to said foreign national employee via said web-based employee service center; providing a list of available transition services 13 to said foreign national employee via said web-based employee service center for completing said transition tasks; prompting said foreign national employee to make at least one request for a transition service 14 from said list of available transitioning services; processing said at least one request for a transition service 15 via said web-based employee service center; and tracking completion of said at least one request for a transition service 16 via said administrative portal.

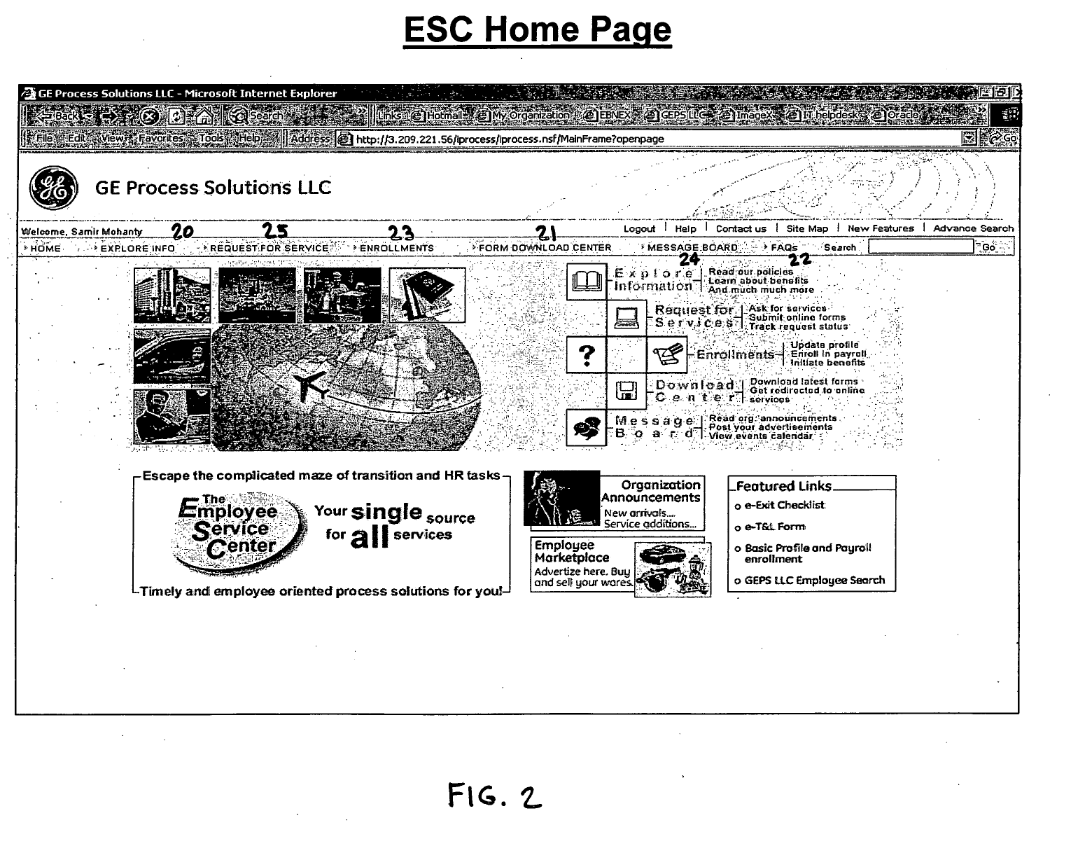

A main component of the method of the invention is the web-based employee service center (“ESC”). FIG. 2. As will be understood in the art, in a preferred embodiment the employee service center is resident on a company's intranet, and allows a user to obtain information and request services through the use of a graphical user interface on a computer. Importantly, because the company's intranet is accessible from the internet, the service center is accessible from any location connected to internet. This feature allows foreign employees with internet access to obtain information and services related to a domestic relocation. The service center includes encryption and security as necessary to safeguard private employee data.

The employee service center of FIG. 2 includes an information center 20, a form download center 21, a frequently asked questions center 22, an enrollment center 23, a message board 24 (employee interaction center), and a request for service center 25. The employee service center also includes an administrative portal, which is accessible only to those employees with administrative privileges to the service center.

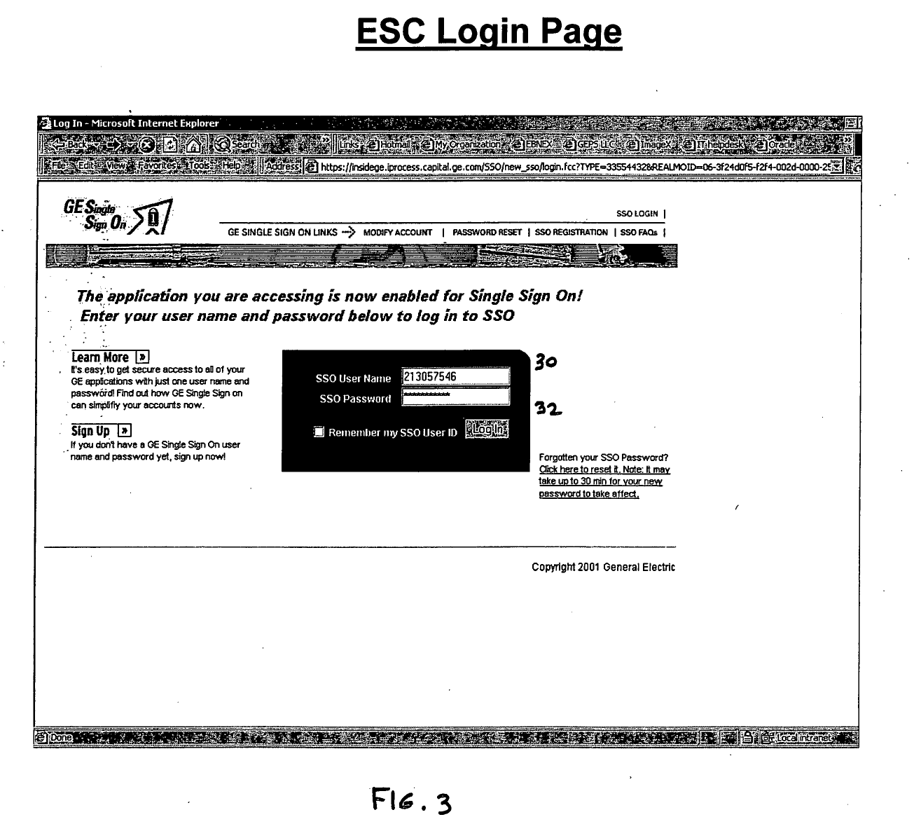

Access to the employee service center by employees, or access to the administrative portal by administrators, is made through the login page shown in FIG. 3. The employee or administrator uses a unique user access identification code 30 and password 32 to enter through the login page of the service center. Employees and administrators receive their unique user access identification code and password from an existing administrator, usually in response to a request from the employee (or administrator) or in response to a request from the appropriate personnel who were involved in arranging the transfer. In a preferred embodiment the employee may request a user identification code and password from the login page. The existing administrators then electronically input identification code and password information for the employee into the ESC, which enables the employee to have access to the ESC upon entering the correct unique user access identification code and password. This provides a second layer of access rights which limits use of the ESC to those employees whose identification and password information has been specifically entered into the ESC system. Thus, in an embodiment where the existing administrators assign the user a unique user access identification code that is the same as the employee's existing identification number, only those users who were specifically input into the ESC system will have access to the ESC system. Thus, the unique user access identification code and password protect the ESC from intrusions by unauthorized users both from within and outside of the company.

Perhaps more importantly, the use of a unique user access identification allows the administrators of the employee service center to keep track of the resources accessed by a particular employee, and further allows the administrators to determine whether the employee is authorized to receive the services that are available on the ESC. Specifically, the administrators will have personal information regarding each employee who has access to the employee service center, such as the employee' name and current address, where the employee is transferring to, where the employee is transferring from, the date of the employee's transfer, and the services that the employee is entitled to receive. In a preferred embodiment, this information is made available to the administrators in a database or spreadsheet by the domestic entity requesting the employee's transfer, and the web-based employee service center is configured so that the administrator can easily upload the employees information into the service center. Accordingly, if an employee then requests a specific service, such as a rental car, the administrators can tell from the ESC whether the employee is authorized to receive the requested service, in this case a rental car. If the employee is authorized to request a rental car, then the administrators will process the employee's request. On the other hand, if the employee is not authorized to request a rental car, the administrators will reject the employee's request.

In a preferred embodiment, the information on the ESC is made available in an organized manner so that an employee can easily access the information that is relevant to that employee. Accordingly, the information is organized with separate tabs for the information center, the form download center, the frequently asked questions center, the enrollment center, the message board (employee interaction center), and the request for service center.

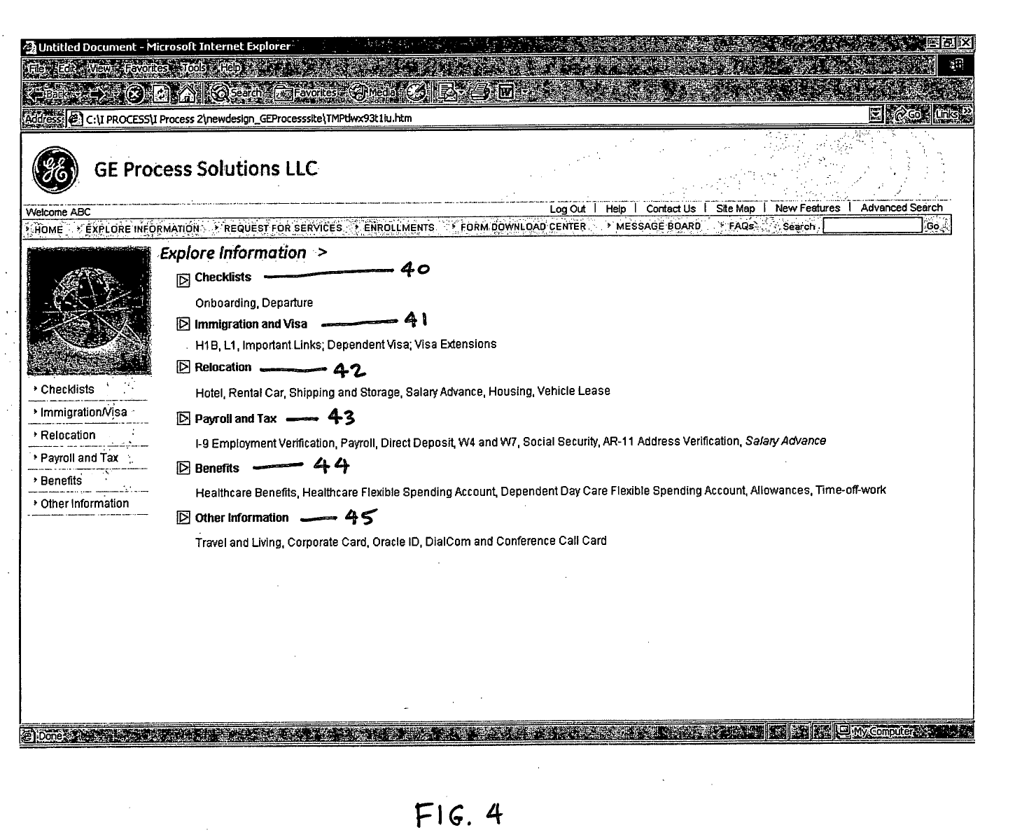

In one embodiment, the information center of FIG. 4 contains information concerning the following: checklists for the employee to follow 40; immigration and visas 41; relocation services 42 such as hotels, car rentals and leases, shipping and storage, payroll and salary advances, and housing; payroll and taxes services 43 such as employment verification, direct deposit, tax forms, and social security; benefits services 44 such as healthcare benefits, flexible spending for healthcare and daycare, allowances, and time off work; and other information 45 such as travel, recreation, and credit cards, and any other type of information. In the preferred embodiment, the checklists in the information center include notations prompting the foreign national employee to complete transition tasks and transition services listed in the checklists. Notably, because the information center is computerized, this allows the information on it to be centrally updated, which may include updating the information to reflect the employer's policies and procedures.

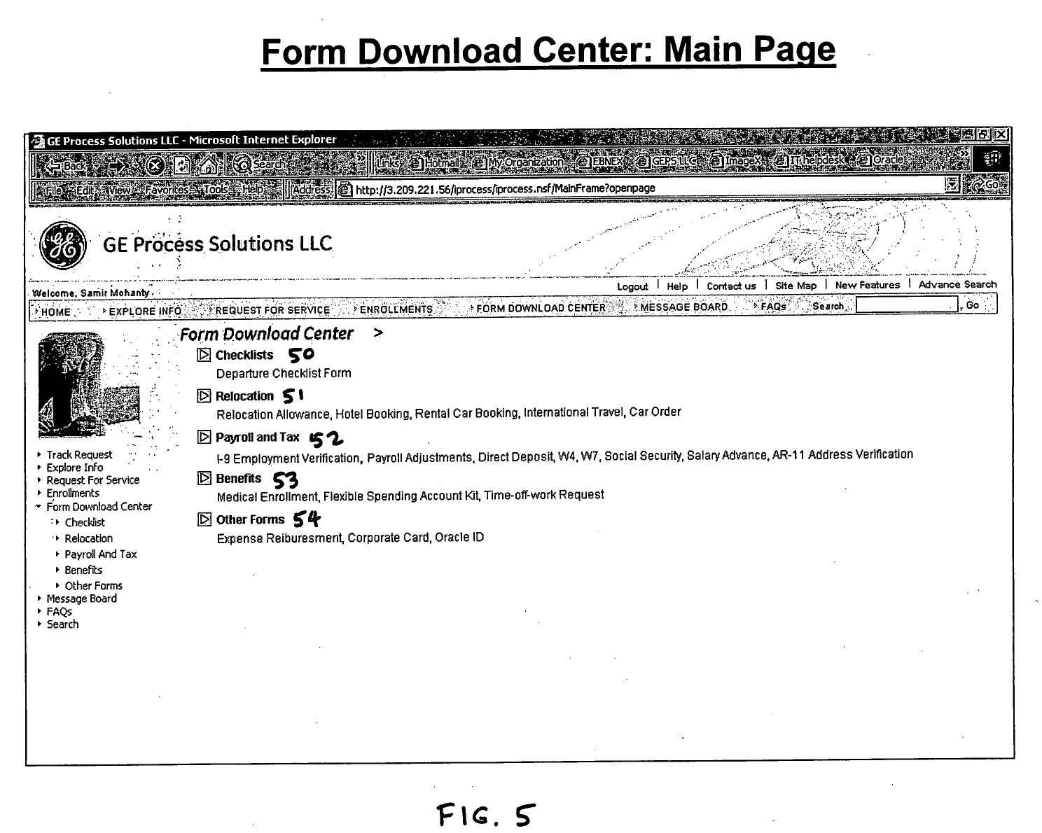

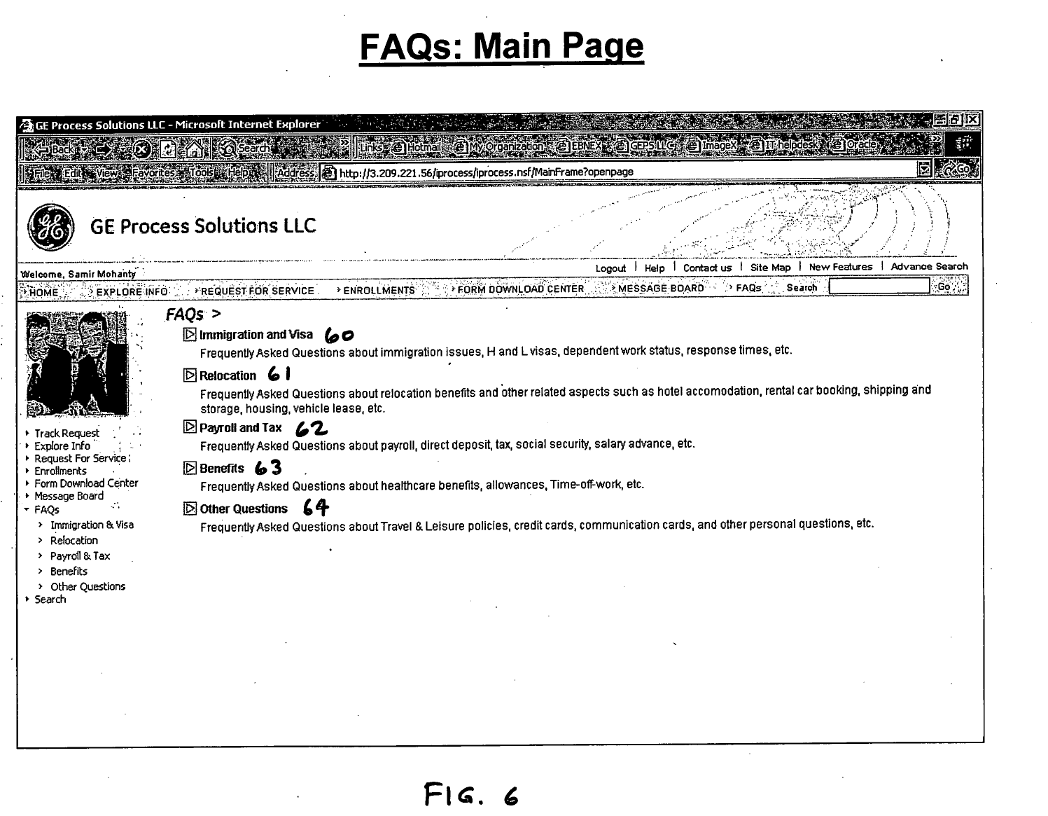

The information in the form download center of FIG. 5 parallels that in the information center, and may contain the following: checklists 50, relocation forms 51, payroll and tax forms 52, benefits forms 53, and other forms 54 (such as expense reimbursement, corporate card, and oracle ID forms). Similarly, in one embodiment the employee service center also contains a frequently asked questions center, FIG. 6, which has sections that parallel those in the information and form download centers and which contains answers to frequently asked questions concerning: immigration and visas 60, relocation 61, payroll and tax 62, benefits 63, and other questions 64. Importantly, in a preferred embodiment the answers provided in the frequently asked questions section will reflect the employer's perspective and decisions on the various questions asked, such that the employee will have an answer that will be in line with the employer's expectations.

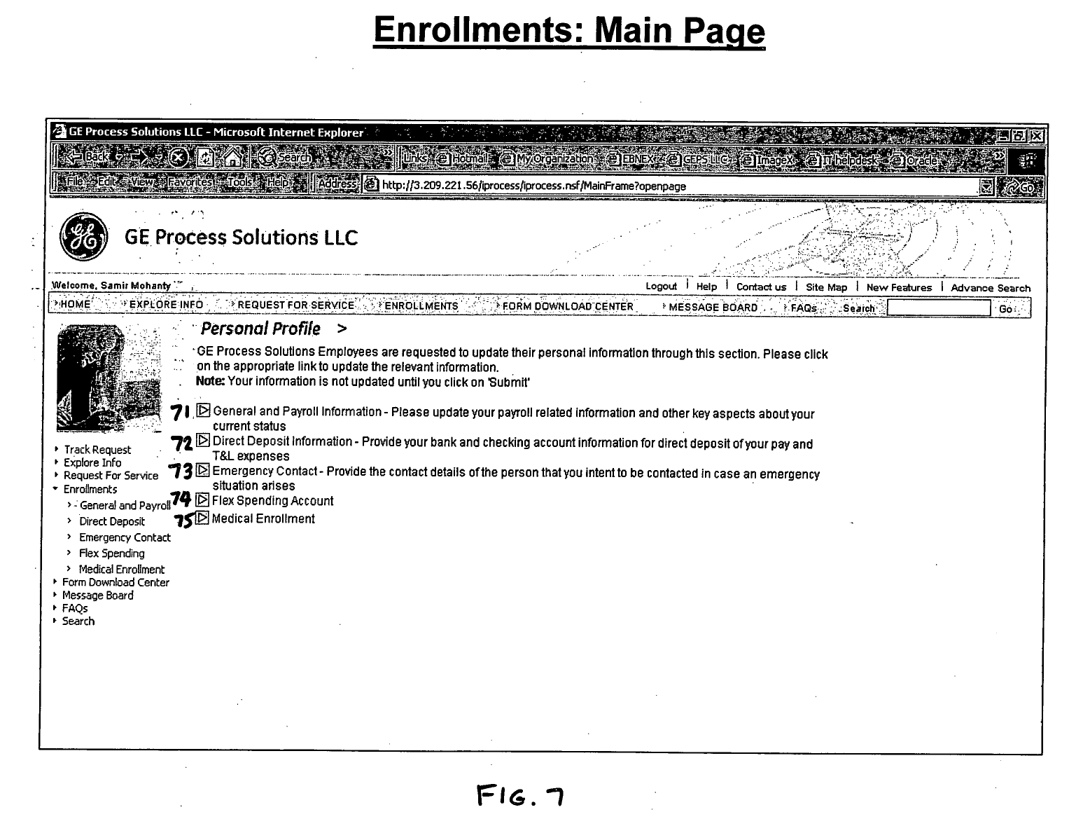

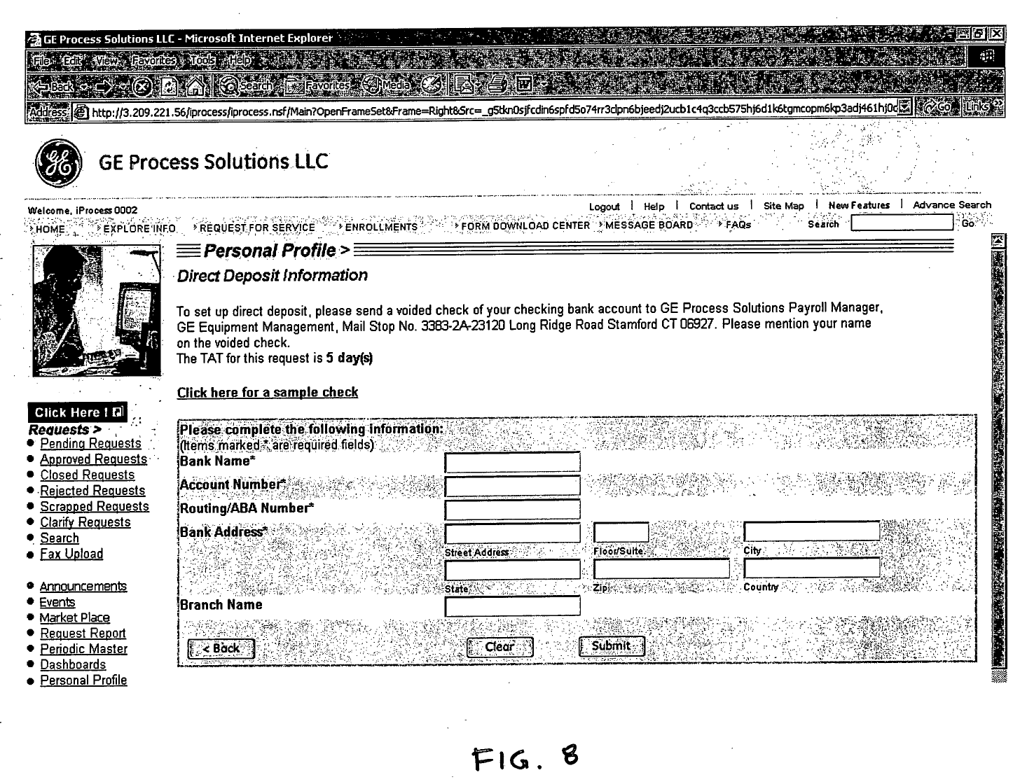

The enrollment center of FIG. 7 allows the employee to input personal information into the ESC. For example, the employee may use the enrollment center to input information for: general information and payroll 71, direct deposit 72, emergency contact 73, and flexible spending account 74, and medical enrollment 75. FIG. 8 shows a specific embodiment of enrollment for direct deposit.

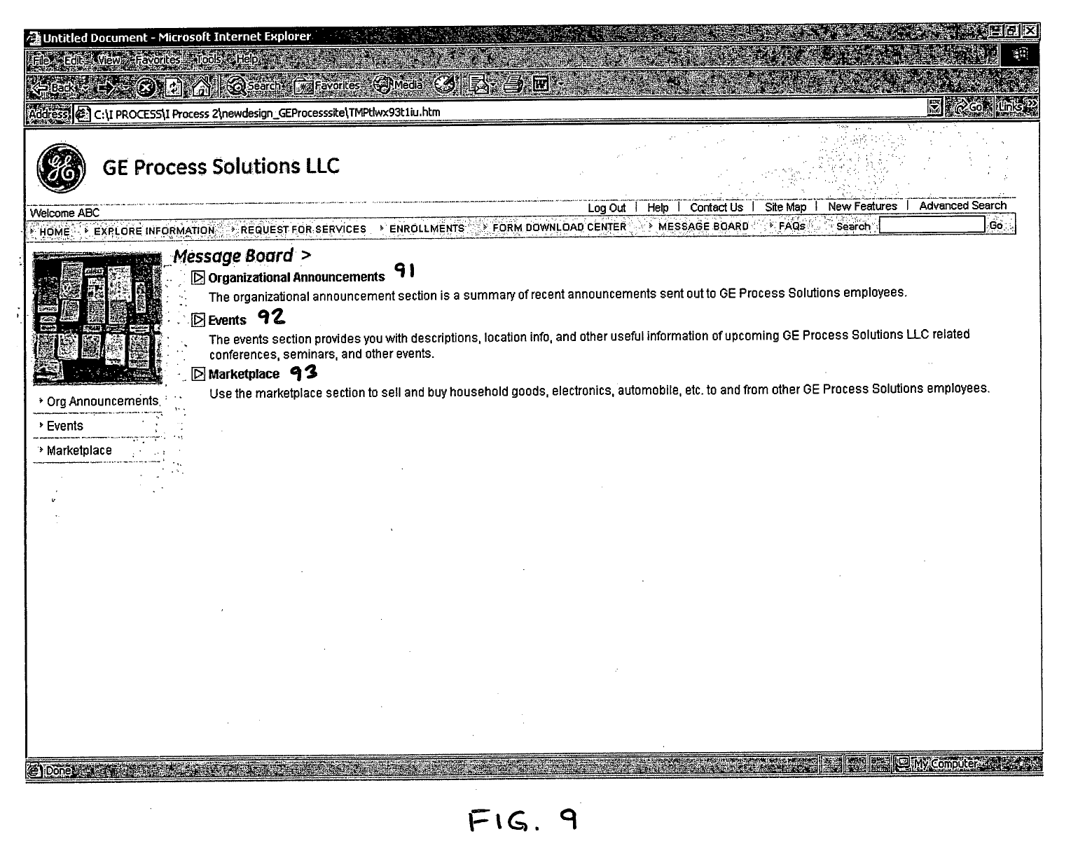

A message board, FIG. 9, is also present in one embodiment of the employee service center, and includes a section for company announcements 91, an events calendar 92, and an employee marketplace 93 where relocating employees may post goods for sale. The message board may further include an employee interaction center which permits employees to identify and communicate with other employees who have been through, or are going through, the transition process. In one embodiment, the message board may include a discussion forum that allows employees to help each other through the transition process. In addition, the process administrators (who process requests for transition services requested by foreign national employees) or superadministrator can monitor the discussion forum and provide answers to the employee's questions, and perhaps convert the questions to permanent entries in the frequently asked questions center. In the preferred embodiment, the administrators or superadministrators choose whether the questions and answers are added to the frequently asked questions center, and under which section the questions are posted.

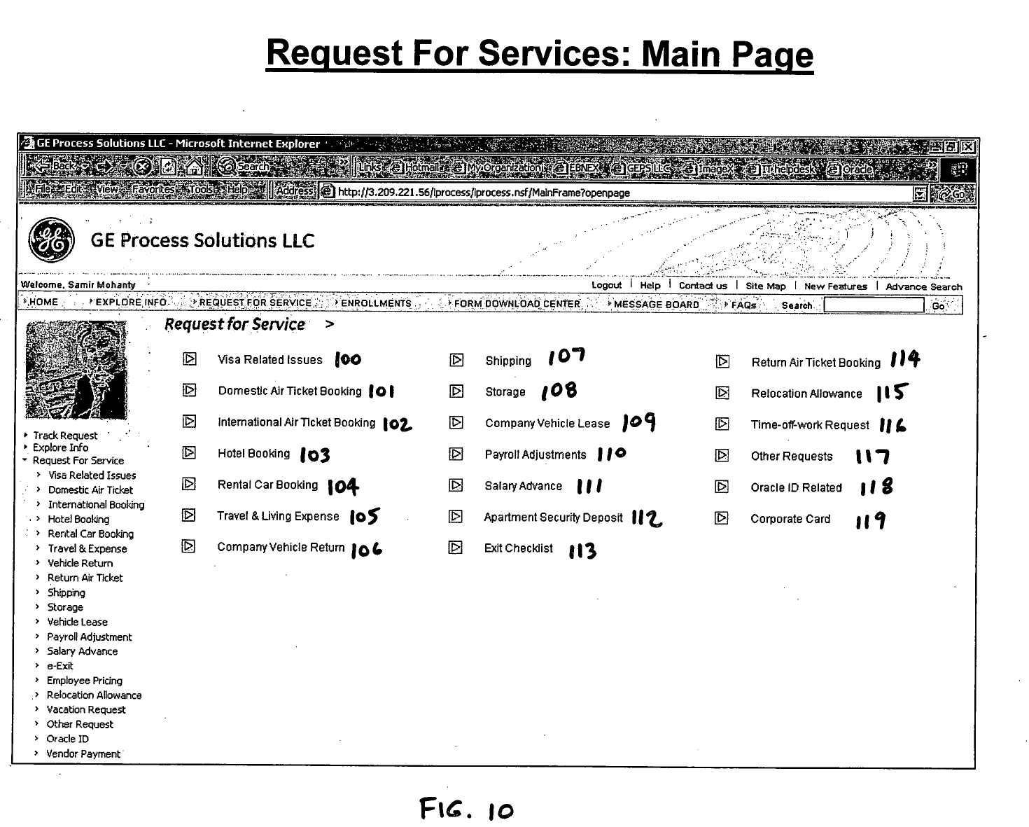

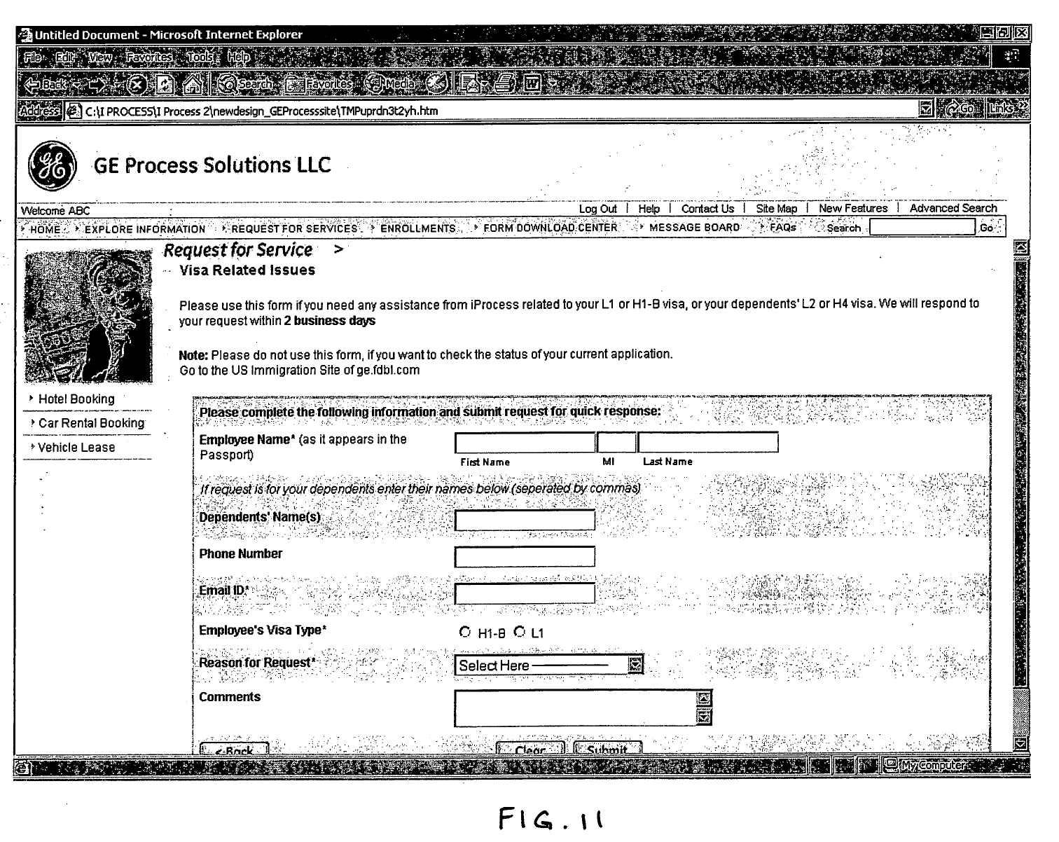

The request for services center of FIG. 10 may include any number of services that a relocating employee would find useful, including: visa related issues 100, domestic air ticket booking 101, international air ticket booking 102, hotel booking 103, rental car booking 104, travel and living expense 105, company vehicle return 106, shipping 107, storage 108, vehicle lease 109, payroll adjustments 110, salary advance 111, apartment security deposit 112, exit checklist 113, return air ticket booking 114, relocation allowance 115, time-off-work request 116, other requests 117, Oracle ID related requests 118, and corporate card related requests 119. FIG. 11 shows a specific embodiment of a request for a visa related service.

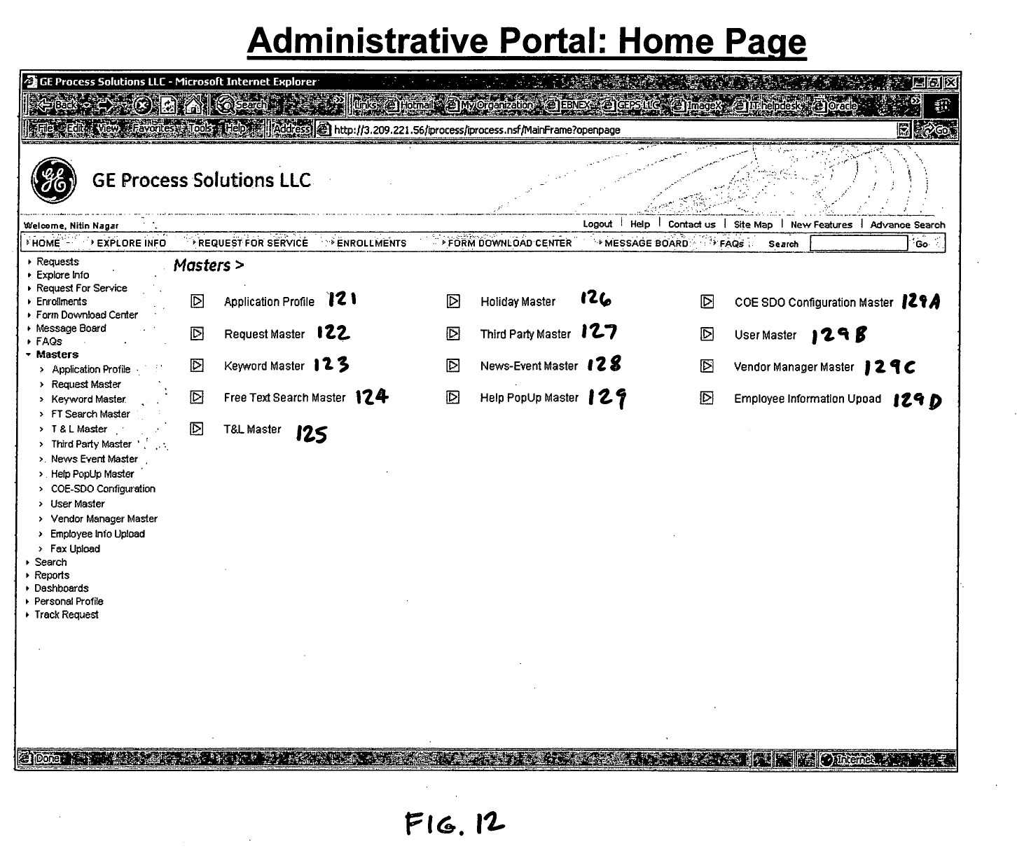

The administrative portal of FIG. 12 in accessible only to process administrators and other administrators who are responsible for monitoring and processing requests. Administrators are given access to the administrative portal through the login page, after their login information is identified by the employee service center as being owned by an administrator. The administrative portal gives process administrators access to all requests made by employees on the ESC system, allowing the administrators to process requests, assign third parties to process requests, assign vendors to certain requests, and edit portions of the ESC to change the functionality or information provided. In the preferred embodiment of FIG. 12 shows numerous functions that are available to administrators through the administrative portal including: application profile 121, request master 122, keyword master 123, free text search master 124, T&L master 125, Holiday Master 126, Third Party Master 127, News-Event Master 128, Help PopUp Master 129, COE SDO Configuration Master 129A, User Master 129B, Vendor Manager Master 129C, and Employee Information Upload 129D.

In another embodiment, the employee service center is pre-configured based on the employee's unique user access identification code so that it makes available only the information that is relevant to the particular employee. Specifically, the web-based employee service center is pre-configured so that particular information is linked to each employees unique user access identification codes. Accordingly, if a foreign employee in India who is designated for transfer to Philadelphia, Pa. enters his or hers unique access identification, the web-based employee service center could be pre-configured so that it makes available information concerning that particular type of move. Therefore, in this example, the employee service center would be configured to provide, in response to this user's unique user access code, specific information concerning a move from India to Philadelphia, Pa., such as immigration information concerning India to United States transfers, specific housing information concerning Philadelphia, specific information concerning Philadelphia city taxes and Pennsylvania state taxes, and specific information concerning car rentals in Philadelphia.

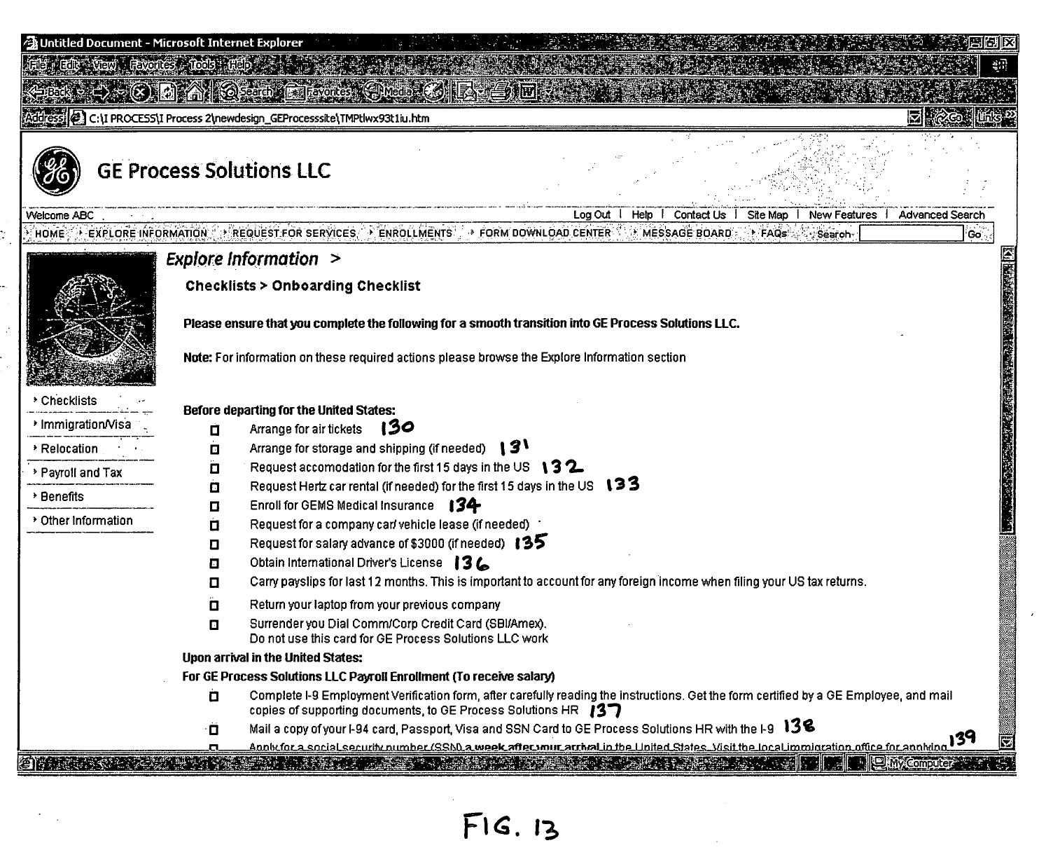

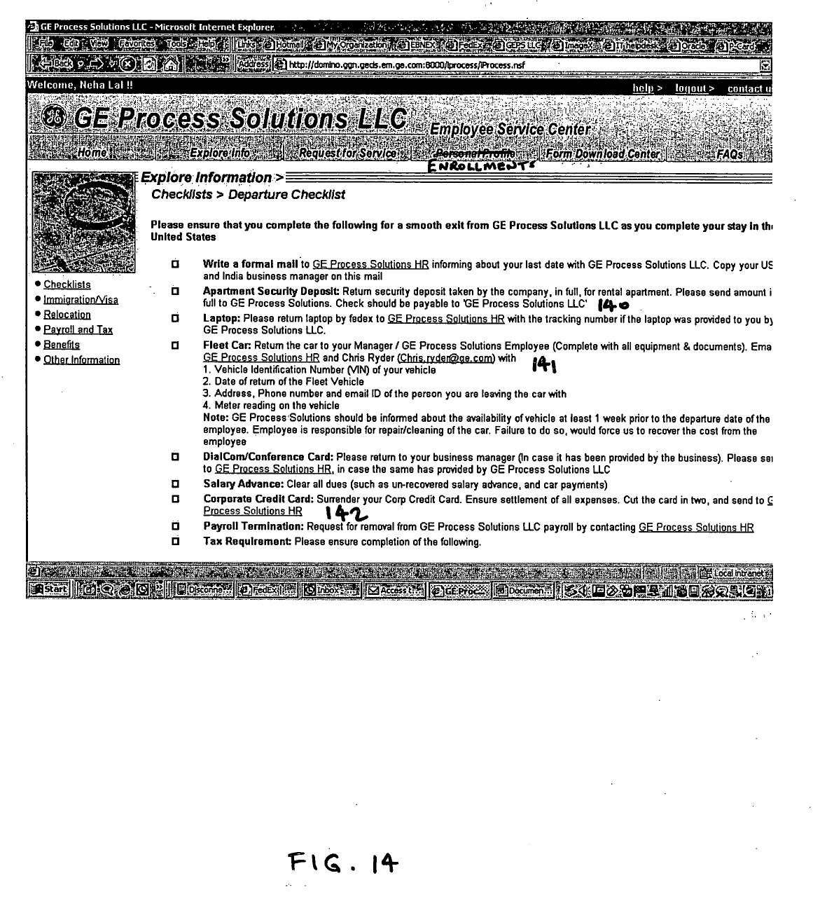

The method of the invention further includes providing a checklist of required tasks to the foreign employee, so that the foreign employee knows what tasks he or she must do in relation to the transfer. In the preferred embodiment, the checklist is available in the information center portion of the ESC (FIG. 4), and contains a list of the tasks that the employee must perform at various times. For example, the checklist can contain a list of the tasks the employee should perform before the employee leaves his or her foreign location. As shown in FIG. 13, the checklist will include information such as arranging for air tickets 130, arranging for storage and shopping 131, requesting accommodations for the first 15 days in the United States 132, requesting a car rental 133, enrolling in the company's medical insurance plan 134, requesting a salary advance 135, obtaining an international driver's license 136 as well as other tasks the employee must perform. Similarly, as shown in FIG. 13, the checklist can contain a list of the tasks the employee should perform when the employee arrives at the domestic location, such as completing necessary immigration forms 137, sending appropriate immigration documents to the company's human resources department 138, and applying for a social security number 139. In addition, as shown in FIG. 14, there may be a checklist containing a list of the tasks the employee should perform at the end of the employee's employment in the United States, such as obtaining any security deposit placed for a rental apartment 140, returning rental or fleet cars 141, and returning any corporate credit or telephone cards 142. In one embodiment, this checklist may be customized to the specific situation for an employee and the related transition. This checklist may also be completed online and reminders for completing incomplete tasks may also be set up for the employee and their managers and administrators. In another embodiment, the checklist may output an account statement for the employee to provide a clear direction on the amount of dues payable to or by the employee to conclude their departure process.

Importantly, the employee service center enables a foreign employee to request a transition service to complete some of the tasks that are included on the checklists. For example, the “Departure” checklist may indicate that an employee should purchase international air tickets (FIG. 13). To assist the employee in performing this task, the employee service center provides a “Request for Service” Center (FIG. 10) that allows a foreign employee to request an international airline ticket. The appropriate department, usually the human resources department, then processes the foreign employee's request for an international ticket, and confirms, through the foreign employee's user access identification code, that the employee is authorized to receive an international air ticket as requested, and then obtains the appropriate ticket if the employee is so authorized. As shown in FIG. 10, the services that a foreign employee may request includes visa related issues 100, domestic air ticket booking 101, international air ticket booking 102, hotel booking 103, rental car booking 104, shipping 105, storage 106, vehicle lease 107, payroll adjustments 108, salary advance 109, medical enrollment 110, relocation allowance 111, travel and living expense reimbursement 112, dues settlement 113, time-off-work request 114, and other requests 115.

Allowing the foreign employee to request a service via the web-based employee service center has many advantages over the prior art. First, because the request is made via the web, it is received immediately by the persons responsible for processing the requests. Accordingly, the time normally associated with mailing such requests, particularly when the requests are mailed internationally, is eliminated, thus shortening the turn-around-time (TAT) or such requests. Second, because the request is made via the web and is routed directly to the person(s) responsible for processing such requests, the possibility of human error, such as having a paper request lost or misplaced, is greatly reduced. Instead, all requests are at all times available to the person(s) responsible for processing such requests, which provides the further advantage of providing a record keeping function that the prior art paper methods do not provide.

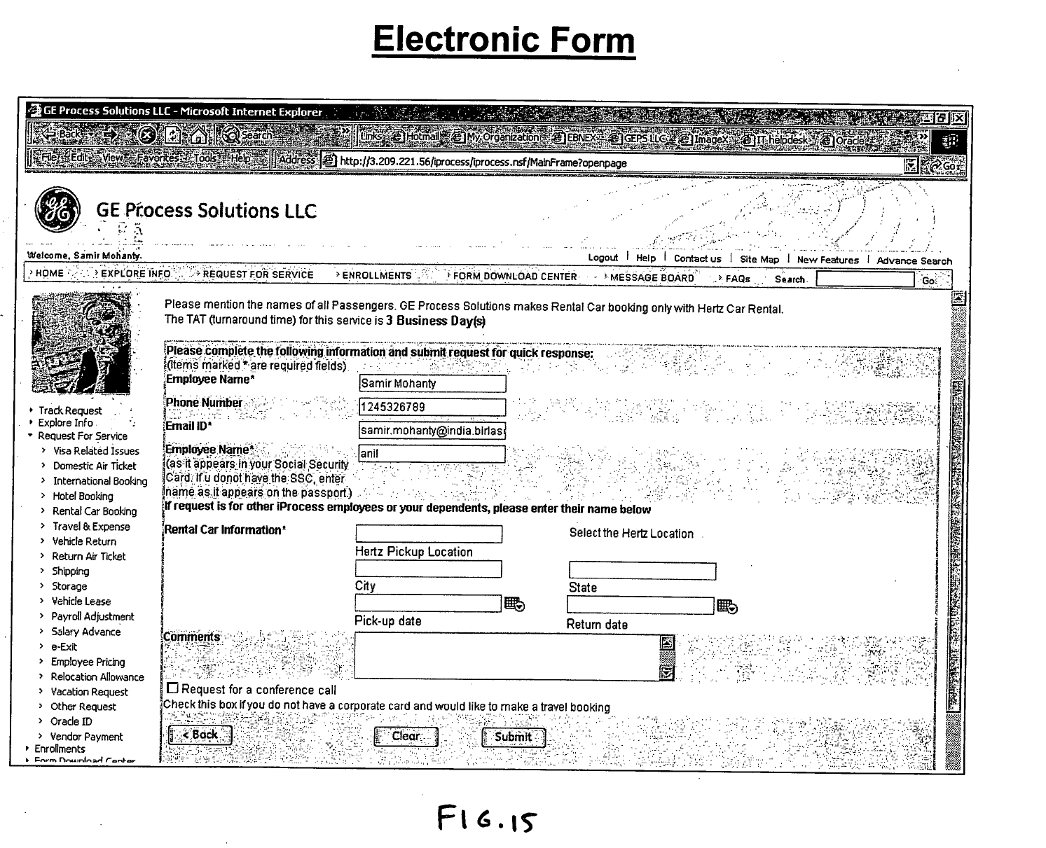

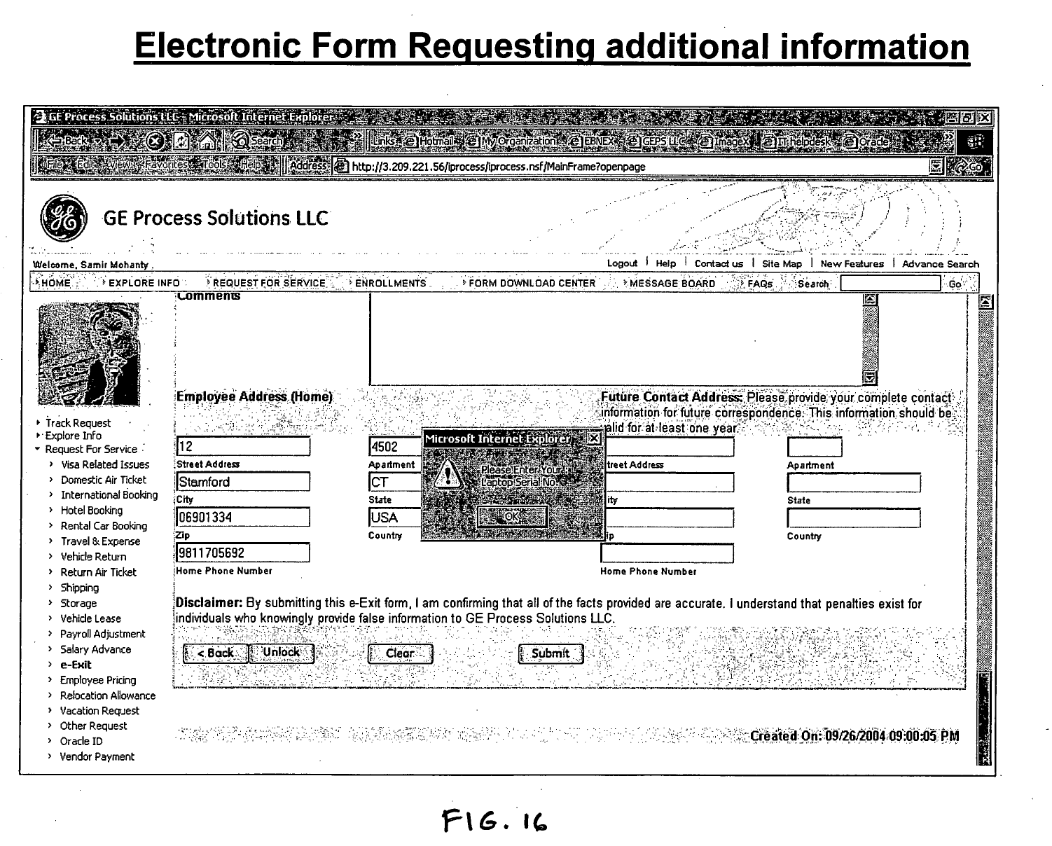

Furthermore, having requests made via a computerized, web-based service center is advantageous because the electronic forms—such as key immigration, tax, health, and insurance forms—provided for employees to complete are configured with various checks to ensure that the employee has completed the form in full, without format errors; and without inconsistent information. An example of an electronic form for car rental requests is shown in FIG. 15. Where an employee fails to complete a certain field in a form, the system can be designed to immediately require the employee to provide the missing information before the form is submitted. FIG. 16. This greatly reduces information entry errors and greatly increases the efficiency of the foreign employee transition process.

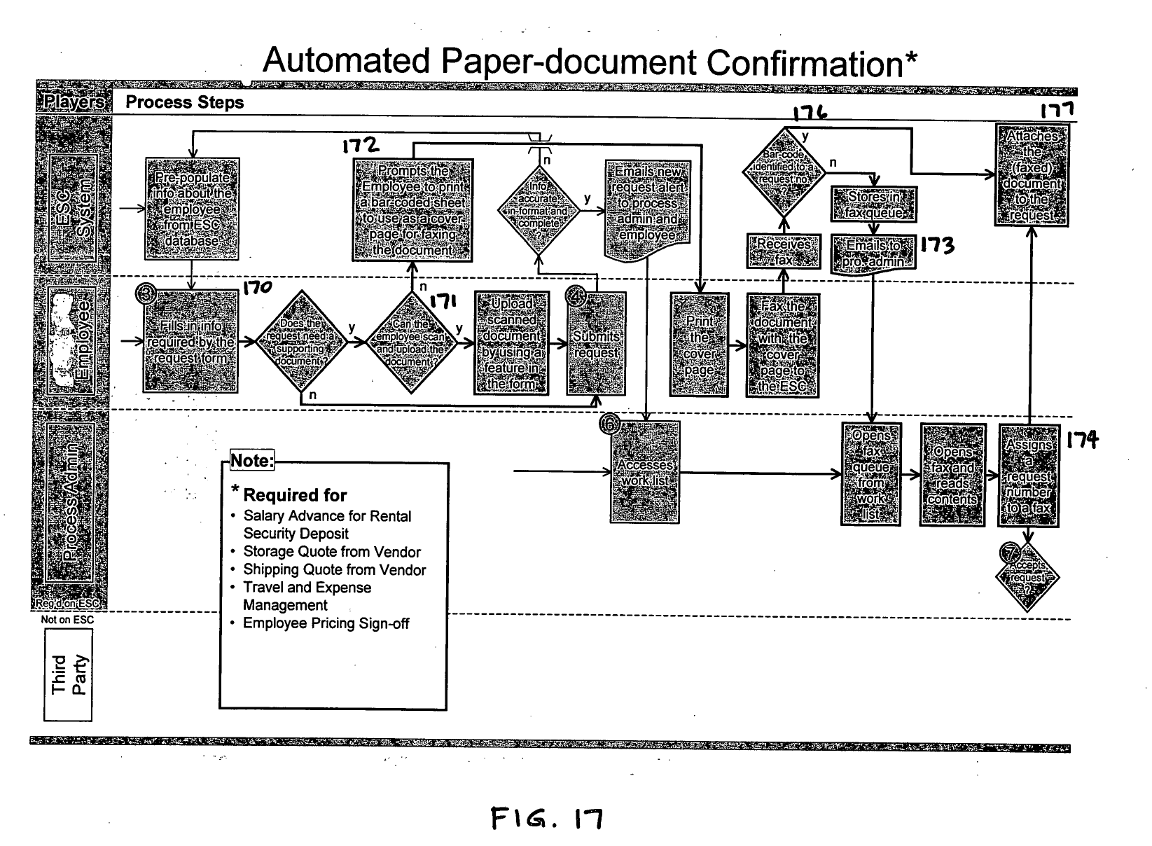

Another useful feature of the web-based employee service center is the ability to receive faxes from employees. FIG. 17. In certain instances, an employee may be required to fax various forms to the web-based employee service center. For example, when an employee requests a salary advance for a rental security deposit or payment of storage or shipping fees, it is desirable to have the employee substantiate those costs by supplying quotes from landlords or companies for those costs. Similarly, when the employee submits a request for the reimbursement of travel expenses, it is desirable to have the employee substantiate the costs by supplying appropriate receipts. In the preferred embodiment of the invention, the employee completes a request for service form for the appropriate service 170. The employee service system then asks the if the employee is capable of scan and uploading documents 171. If the employee cannot scan and upload documents, the system prompts the employee to print a bar-coded sheet to use as a cover page for faxing the supporting documentation to the employee service center 172. The bar code on the sheet is keyed to the specific request for which the documentation relates. Upon receipt of the fax, the system notifies the process administrator and the employee that the fax has been received 173. In one embodiment, the process administrator reviews the fax to determine which request the fax relates to 174. The process administrator then attaches the request to the appropriate request 177. In an automated embodiment, the ESC reads the bar code 176 and attaches the documentation to the appropriate request based on the bar code 177.

The requests are processed by the appropriate departments, usually human resources, finance, or payroll, through the administrative portal of the employee service center. FIG. 12. The administrative portal gives the appropriate process administrators access to each request, allowing the administrators to review the requests and process them as required.

In one embodiment, the web-based service center is configured to automatically assign requests to certain process administrators, based on factors such as the workload and areas of expertise of the various process administrators. For example, the web-based service center can be configured to assign all car leasing requests to one process administrator, and all payroll adjustment requests to another process administrator. This permits the process administrators to specialize in particular types of requests, which reduces the TAT associated with requests. In addition, the web-based service center can be configured to distribute the requests evenly amongst several process administrators with the same specialty. For example, if there are two process administrators who handle car leasing requests, the web-based service center can be configured to alternate assignment of new requests to each process administrator. In an alternate embodiment, process administrators do not have specialty areas and the ESC assigns requests to process administrators on the basis of workload. This embodiment allows each process administrator to become familiar with several types of processes which would allow more flexibility in the scheduling and assigning of requests.

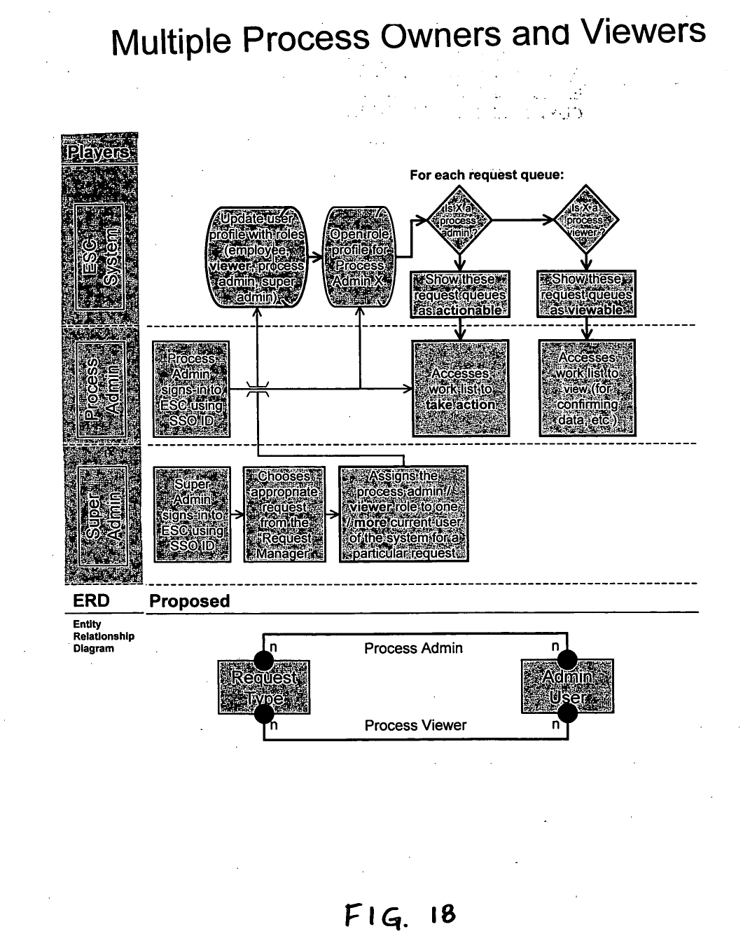

In yet another embodiment, the assignment of the requests can be made manually by an administrator or superadministrator. The administrator can, through the administrative portal, assign the requests to specific process administrators on the basis of many factors, including the specialty area of each administrator and the workload of each process administrator. Or the administrator can assign the requests on the basis of workload alone, where it is desired that each administrator become familiar with processing different kinds of requests. In another alternate embodiment shown in FIG. 18, several administrators may be assigned to each request such that some of the administrators can actually process the request and some of the administrators may only view the request. This permits other administrators to view an employee's information to confirm data or to check the status of a request.

The web-based employee service center further provides numerous other advantages to the managers or superadministrators who oversee the processing of foreign employee requests. First, because the service center allows the employee requests to be received by a central computer, the information concerning the making and processing of all requests is resident on the computer and managers are able to obtain consolidated reporting and electronic notifications concerning the requests received and processed by the request center. The consolidated reporting and electronic notifications allows the managers to better respond to requests and balance the workload amongst administrators. For example, in a preferred embodiment, the system is designed to regularly check the TAT of pending requests. If the system determines that the current TAT (the time between the date on which the request was received and the date on which the system is checking on the status of the request) on a particular request exceeds the specified TAT, the system generates and sends an email to the proper process administrator(s) or superadministrator (an administrator or manager who monitors the process administrators), notifying them of the unprocessed request. This allows a manager or superadministrator to make escalations as necessary to reduce the TAT associated with certain requests (including those that have already exceeded their expected TAT). In addition, the consolidated reporting and electronic notifications allows the manager to keep track of the number and type of requests received and re-distribute work evenly amongst administrators as necessary, to prevent bottlenecks or delays from forming in the processing. The consolidated reporting also allows a manager to keep track of the performance of each process administrator, which permits the manager to redistribute requests as necessary for performance-based reasons. Furthermore, because the web-based employee service center centralizes all requests for foreign employees, it encourages dialog between administrators on matters of common interest that arise from the processing of the requests.

The administrative portal would preferably be configured to provide the administrator with several options in responding to the request. In a preferred embodiment, the administrative portal would allow the administrator to approve the request, ask the employee for clarification concerning the request, or reject the request. For example, the administrator may review a car rental request and determine from the employee's user access identification code that the employee is not authorized to rent a car. In that case, the administrator would select the “rejection” option on the portal, which would, in one embodiment, be configured to send the employee an email rejection of the service.

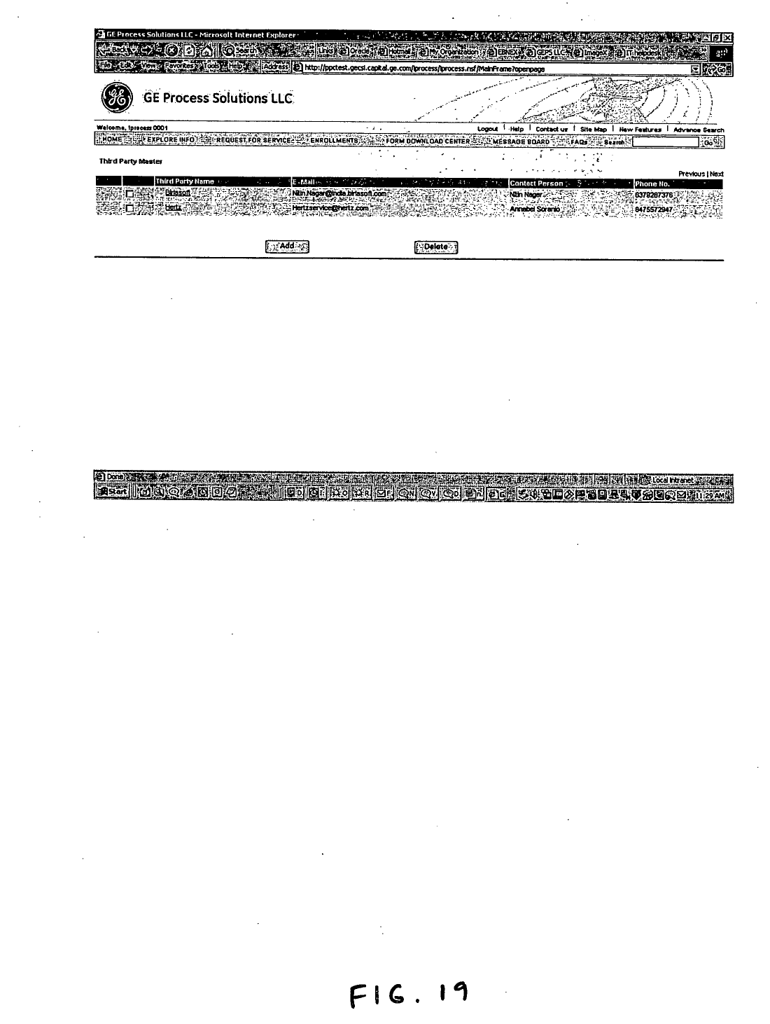

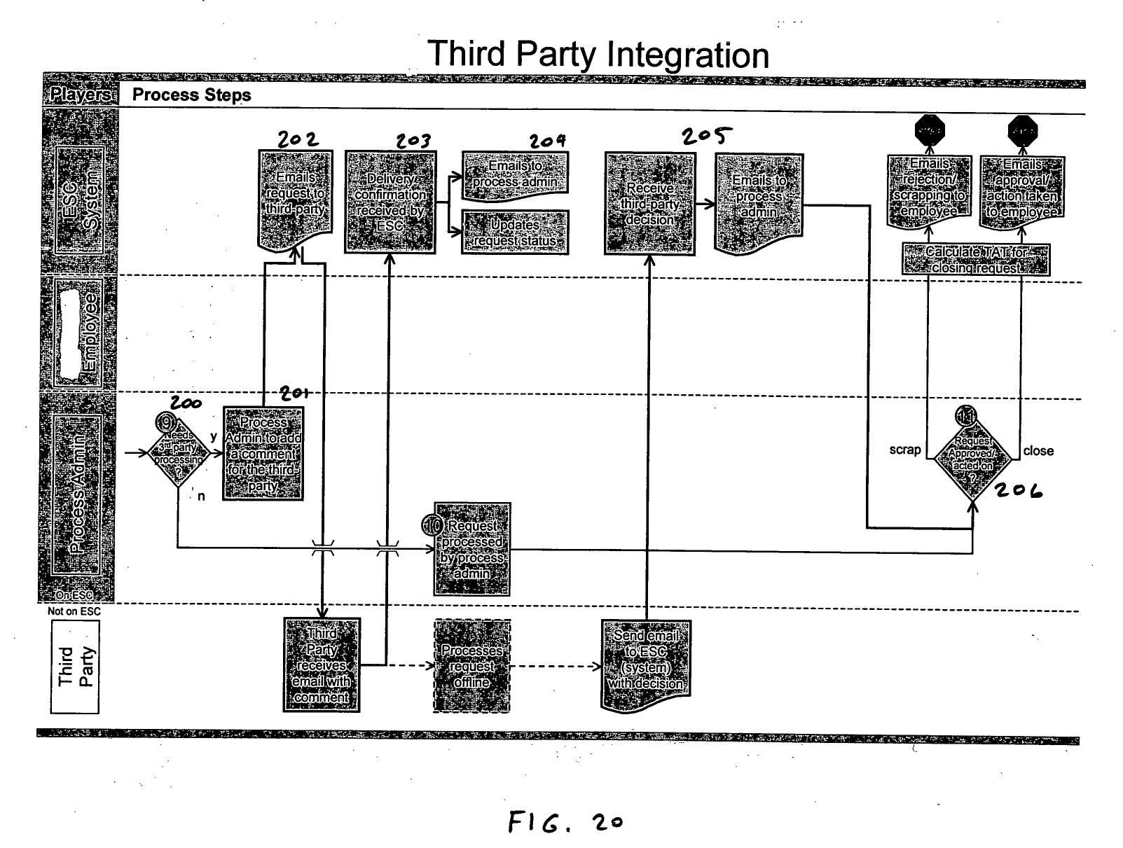

In a preferred embodiment, the administrative portal to the ESC is configured to permit the process administrator to assign a third party vendor to any of the services that are available to the foreign employee. FIG. 19. In addition, the administrative portal is configured to send the appropriate third party vendor a request for a service via encrypted email, if the process administrator approves the request for third party processing. FIG. 20. Thus, for example, a process administrator may assign the rental car company “Hertz™” as a third party vendor for rental car bookings. A foreign employee would make a request through the ESC for a rental car in a certain city on certain dates. If the administrator determines that the employee is authorized to rent the car in the city and on the dates specified, the process administrator would approve the request for third party processing 200. In a preferred embodiment, the administrator also has the ability to add comments for the third party when approving the request 201. Upon approval of the request, the request or the relevant information within the request (car desired, dates, and city) would be sent (via email) immediately via encrypted email to Hertz™, the rental car company assigned to the rental car service in the portal 202. In the preferred embodiment, the encrypted email to Hertz™ would include a read receipt, which would cause an email to be sent from Hertz™ to the ESC upon reading of the email by Hertz™ 203. Upon receipt of the read receipt email from Hertz™, the ESC is configured to then send an email to the proper administrators indicating that the email had been read, and to update the status of the request to show that the request had been received by Hertz™ 204. The service center is configured to receive by email the third party's decision or offer concerning the request 205—that is, whether the third party can fill the request and at what terms—and to notify the process administrator when the third party response is received. Then the process administrator can review the third party's decision and either approve or reject the decision 206. Upon approval of the third party's decision, the employee service center automatically sends an email to the employee notifying the employee of the approval of the request. Upon rejection of the third party's decision, the employee service center automatically sends an email to the employee notifying the employee of the rejection. As will be appreciated by administrators of these types of requests, configuring the portal to automatically send requests to third party vendors and automatically process read receipt email reduces the TAT on such requests, and also reduces the possibility of delays caused by human error such as errors in copying the information from the request and delays in mailing the request to the third-party vendor.

The administrative portal for the web-based service center also allows the manager or superadministrator to view and print customized reports regarding both process administrator performance and foreign national employee activity on the web-based service center. As earlier noted, because the requests are received by a central web-based service center, and because the requests are processed through the administrative portal of the web-based service center, the activity on all requests can be tracked. Accordingly, the system has in its memory information concerning all requests that have been received, when they were received, and also knows whether the requests have been timely processed by a process administrator. In a preferred embodiment, the superadministrator can print customized reports showing the status of the requests, which allows the superadministrator to make escalations and changes as necessary to maximize the processing of requests.

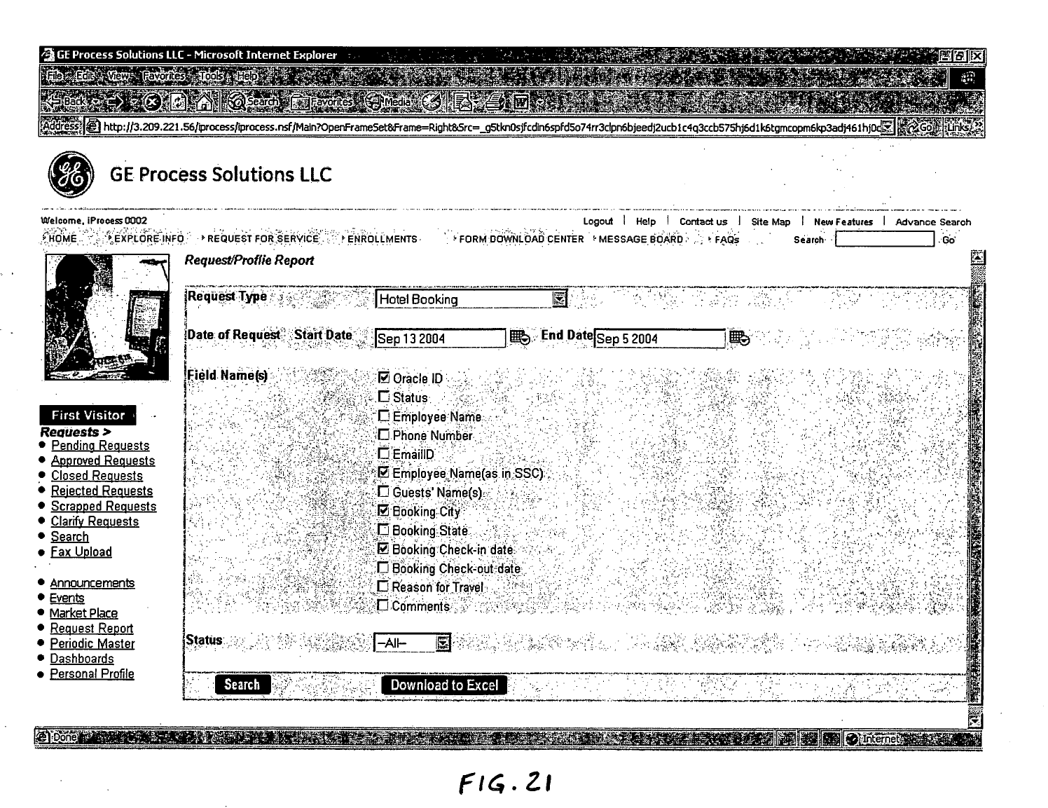

Because the requests are received by a central web-based service center, the superadministrator can also print customized reports regarding the requests themselves. FIG. 21. For example, a superadministrator can print out a report showing all requests for car leases that shows the value of the leases sought. Likewise, a superadministrator can print out a report showing all requests for international airline tickets and the time of the requests to check whether foreign national employees were timely making their requests for such tickets. In the preferred embodiment the report can be customized to show any fields from any of the request forms submitted by foreign national employees.

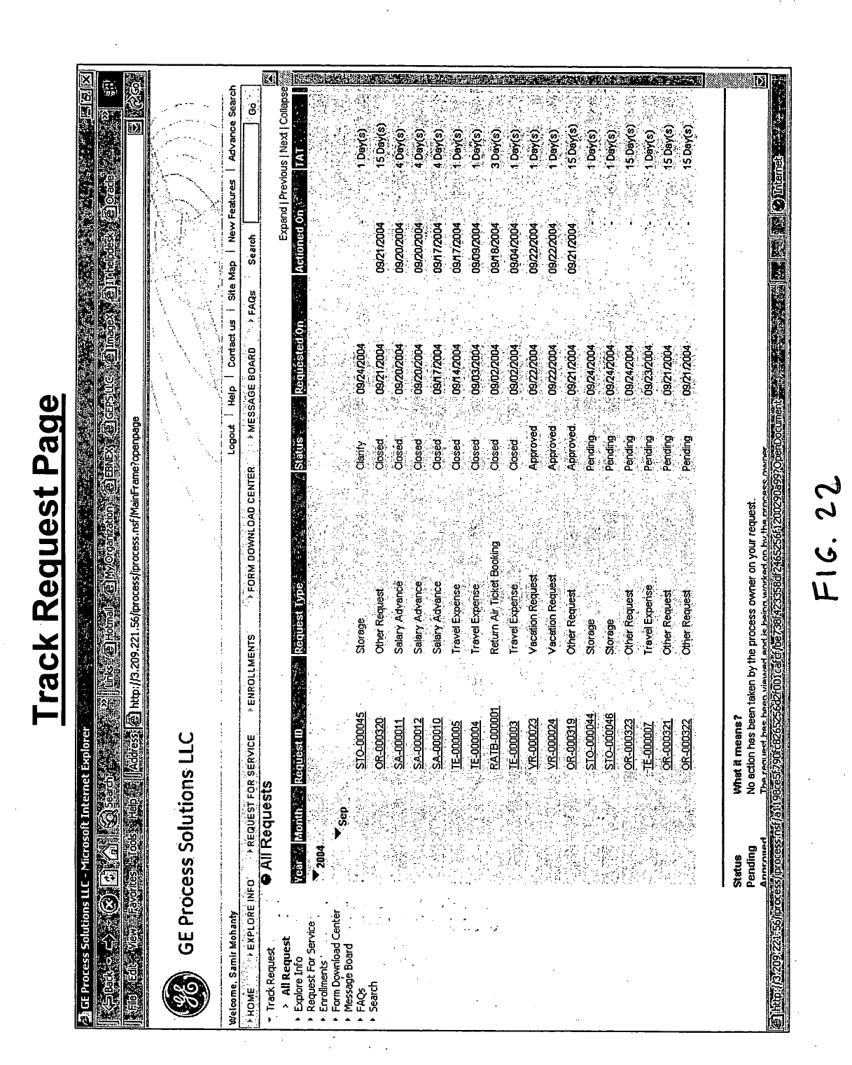

Another very useful and novel feature of the invention is the ability to track the foreign employee's completion of the tasks on the ESC's checklists. At any time after the foreign employee was assigned a unique user access identification code, the network administrator can check the web logs to see which portions of the ESC were accessed by particular employees. In addition, an administrator can, at any time, check if the foreign employee has made any service requests, and if the request was subsequently processed and completed. See FIGS. 22 & 23. As noted above, because the requests are received and processed on a central computer, all of the information concerning the making and processing of the requests is resident in the computer's memory. In situations where an employee has not made any service requests, the administrator can make an assessment, based on information available to the administrator such as the date on which the employee arrived or is scheduled to arrive in the United States, as to whether the employee needs to be contacted regarding certain services the employee needs to request or certain tasks the employee needs to complete.

From the above, it should be understood that the embodiments described are merely exemplary and that a person skilled in the art may make variations and modification to the shown embodiments without departing from the spirit of the invention. All such variations and modifications are intended to be included within the scope of the invention as defined by the appended claims.

What is claimed is:

1. A method for transitioning a foreign national employee from a foreign location to a domestic business location, the method comprising:
providing a web-based employee service center comprising an information center, a form download center, an enrollment center, a request for service center, and an administrative portal;
assigning a unique user access identification to a foreign national employee to be transitioned to a domestic business location from a foreign location, to allow said foreign national employee to access said employee service center;
providing at least one checklist of required transition tasks to said foreign national employee via said web-based employee service center;
providing a list of available transition services to said foreign national employee via said web-based employee service center for completing said transition tasks;
prompting said foreign national employee to make at least one request for a transition service from said list of available transitioning services;
processing said at least one request for a transition service via said web-based employee service center; and
tracking completion of said at least one request for a transition service via said administrative portal.

2. The method according to claim 1, said information center providing information on at least one topic to said foreign national employee, said at least one topic selected from the group consisting of: task checklists, immigration, visas, hotels, car rentals/leases, shipping, storage, relocation allowances, salary advances, housing, employment verification, payroll adjustments, direct deposit, taxes, social security, benefits, travel, recreation, and credit cards.

3. The method according to claim 1, said form download center providing at least one form on at least one topic to said foreign national employee, said at least one topic selected from the group consisting of: immigration, visas, hotels, car rentals/leases, shipping, storage, relocation allowances, salary advances, housing, employment verification, payroll adjustments, direct deposit, taxes, social security, benefits, travel, recreation, and credit cards.

4. The method according to claim 1, wherein said web-based employee service center further comprises a frequently asked question center.

5. The method according to claim 4, said frequently asked question center providing information on at least one topic to said foreign national employee, said at least one topic selected from the group consisting of: task checklists, immigration, visas, hotels, car rentals/leases, shipping, storage, relocation allowances, salary advances, housing, employment verification, payroll adjustments, direct deposit, taxes, social security, benefits, travel, recreation, and credit cards.

6. The method according to claim 1, wherein said web-based employee service center further comprises a message board center.

7. The method according to claim 6, said message board center providing access to information on at least one topic to said foreign national employee, said at least one topic selected from the group consisting of: organizational announcements, events, and marketplace items for sale.

8. The method according to claim 1, further comprising:
said foreign national employee inputting information on at least one topic into said enrollment center, said at least one topic selected from the group consisting of: general information, payroll information, direct deposit information, emergency contact information and benefit enrollment.

9. The method of claim 8, wherein said enrollment center rejects the information input by the foreign national employee if said information is incomplete or inconsistent and prompts said employee to correct the incomplete or inconsistent information.

10. The method according to claim 1, further comprising:
said foreign national employee inputting information for said at least one request for a transition service into said request for service center, said request being selected from the group consisting of: immigration, visas, domestic air travel, international air travel, hotel reservations, car rentals/leases, payroll adjustments, relocation allowances, salary advances, medical enrollment, vacation requests, credit cards, shipping, storage, and user access identification.

11. The method of claim 10, wherein said request for service center rejects the information input by the foreign national employee if said information is incomplete or inconsistent and prompts said employee to correct the incomplete or inconsistent information.

12. The method according to claim 1, wherein said processing of said at least one request for a transition service includes determining if said request contains all necessary information; and
(a) if said request does not contain all necessary information, notifying said employee that missing information or clarification is needed; or
(b) if said request contains all necessary information, continuing processing of said request.

13. The method according to claim 12, wherein notifying is by email.

14. The method according to claim 12, wherein notifying is made via the request for service center of the web-based employee service center and wherein said processing further includes prompting foreign national employee to correct the request to include all necessary information.

15. The method according to claim 1, wherein said processing of said at least one request for a transition service comprises:
identifying a foreign national employee making said request via said user access identification;
determining if said foreign national employee qualifies for said transition service; and
(a) if said foreign national employee qualifies for said transition service, completing said at least one request for a transition service; or
(b) if said foreign national employee does not qualify for said transition service, denying said at least one request for a transition service.

16. The method according to claim 15, further comprising notifying said foreign national employee of said completing or denying of said request for a transition service via said web-based employee service center.

17. The method according to claim 16, wherein said notifying is by e-mail.

18. The method according to claim 1, wherein said processing of said at least one request for a transition service comprises
said web-based employee service center automatically sending a third party vendor a request email containing information necessary for the third party vendor to process the request, said email having return receipt capability; and
said web-based employee service center automatically notifying the process administrator that the third party vendor has received the request email when said return receipt email is received by said web-based employee service center.

19. The method according to claim 18, wherein said request email is encrypted.

20. The method according to claim 1, wherein said completion of said at least one request for a transition service is accomplished by a third party vendor.

21. The method according to claim 1, wherein said web-based employee service center is capable of receiving faxes, and said processing of said at least one request for a transition service includes obtaining at least one form faxed from said foreign national employee to the said web-based employee service center and attaching said at least one faxed form to said foreign national employee's request.

22. The method according to claim 21, wherein said documentation is attached to said request by a process administrator.

23. The method according to claim 21, further comprising
prompting the employee to print a sheet having a bar-code to use as a cover page for faxing supporting documentation to the employee service center when said employee makes a request for a transition service;
the web service center notifying the process administrator and the employee when a fax of supporting documentation is received that includes said sheet having a bar-code; and
the web service center attaching said fax to the appropriate request based on said sheet having a bar code.

24. The method according to claim 1, wherein said web-based service center includes a login page wherein a foreign national employee can request a unique user identification.

25. The method according to claim 24, wherein said foreign national employee is assigned said unique user identification in response to a request made by said foreign national employee on the login page of said web-based employee service center.

26. The method according to claim 1, further comprising uploading transition information concerning the foreign national employee into said web-based employee service center.

27. The method according to claim 26, further comprising:
pre-configuring said web-based employee service center to display only information relevant to said foreign national employee based on said transition information.

28. The method according to claim 1, wherein said at least one checklist of required transition tasks is selected from the group consisting of: tasks required before departure from foreign location, tasks required upon arrival to domestic location, and tasks required befire departure from the domestic location.

29. The method of claim 1, wherein tracking completion of said at least one transition task and processing of said at least one request for transition service comprises
notifying said foreign employee and the process administrator for the request if said request has been accepted by the web-based employee service center;
notifying said foreign national employee of the expected turnaround time of the request;
monitoring whether the turnaround time on the request has been exceeded;
notifying the process administrator and the superadministrator of the web-based employee service center if said turn around time was exceeded.

30. The method of claim 29, wherein notifying the process administrator and the superadministrator is by email, and wherein said email requests the process administrator to explain the reason for the delay in processing the request.

31. The method according to claim 1, wherein said processing of said at least one request for a transition service comprises assigning a process administrator to process said request.

32. The method according to claim 1, wherein said processing of said at least one request for a transition service comprises assigning a plurality of process administrators to process said request.

33. The method according to claim 1, wherein said processing of said at least one request for a transition service comprises assigning at least one process administrator and at least one process viewer to said request.

34. The method according to claim 1, further comprising said web-based service center assigning for processing said at least one request for a transition service to either a primary process administrator or a secondary process administrator based on the relative workloads of said primary process administrator and said secondary process administrator.

35. The method according to claim 1, wherein said administrative portal has a dynamic report generator having the ability to print more than one kind of report.

36. The method according to claim 1, wherein said administrative portal can track the performance history of all process administrators.

37. The method according to claim 36, wherein an administrator assigns for processing said at least one request for a transition service to a process administrator based on the performance history of said process administrator.

38. The method according to claim 36, wherein said administrator reassigns for processing said at least one request for a transition service based on negative performance history of the process administrator to whom the request had been originally assigned.
